(19) United States
(12) Patent Application Publication
(10) Pub. No.: US 2024/0403318 A1
(43) Pub. Date: Dec. 5, 2024

(54) STORAGE SYSTEM AND MANAGEMENT METHOD OF STORAGE SYSTEM

(71) Applicant: Hitachi, Ltd., Tokyo (JP)

(72) Inventors: Kazuki TOGO, Tokyo (JP); Akira Deguchi, Tokyo (JP); Hideyuki Koseki, Tokyo (JP); Hiroki Fujii, Tokyo (JP); Akihiro Hara, Tokyo (JP)

(73) Assignee: Hitachi, Ltd., Tokyo (JP)

(21) Appl. No.: 18/464,649

(22) Filed: Sep. 11, 2023

(30) Foreign Application Priority Data
May 31, 2023 (JP) 2023-089804

(51) Int. Cl. G06F 16/27

(52) U.S. Cl. CPC G06F 16/27

(57) ABSTRACT

A storage system includes a plurality of nodes each of which includes a processor, in which when a replication source volume in a replication source storage system connected to the storage system is replicated to a plurality of nodes of the storage system, any one of the processors generates a first replicated volume by replicating the replication source volume of the replication source storage system in a first node among the plurality of nodes, and generates a second replicated volume mapped to the first replicated volume in a second node among the plurality of nodes.

### BACKGROUND OF THE INVENTION

### 1. Field of the Invention

The present invention relates to a storage system and a management method of the storage system.

### 2. Description of Related Art

The number of users who replicate data of an actual business and secondarily use the replicated data for batch, analysis, or the like in various applications has increased. The secondary use is implemented for a system in a single site, and to utilize resources that can be extended flexibly and instantly in a public cloud, there are also use cases in a hybrid cloud where actual business data in an on-premises site is replicated to a cloud site such that the replicated data is secondarily used. The data secondary use is important for improving and extending a user's business, and a storage system is required to instantly replicate a volume of a storage destination of secondary use data from actual business data and to scale out the replicated volume.

As a technique of scaling out the volume in a loosely coupled scale-out storage architecture, for example, JP2019-101703A discloses a technique (scale-out technique) of adding a storage node to a storage system to reduce a load of each storage node and to improve performance of the storage system.

In the scale-out technique in the related art, after adding a storage node, a process of moving the volume from an overloaded node to the added storage node is required. Here, it is necessary to move the full data of the volume. When the scale-out technique is used for the secondary use, the secondary use can start after fully copying data of an actual business to another storage node, and thus cannot be instantly used.

An object of the present invention is to improve a convenience of secondary use of a volume by reducing a period of time required to scale out the volume such that the secondary use can instantly start.

### SUMMARY OF THE INVENTION

To achieve the above-described object, according to an aspect of the present invention, there is provided a storage system including a plurality of nodes each of which includes a processor, in which when a replication source volume in a replication source storage system connected to the storage system is replicated to the plurality of nodes of the storage system, any one of the processors generates a first replicated volume by replicating the replication source volume of the replication source storage system in a first node among the plurality of nodes, and generates a second replicated volume mapped to the first replicated volume in a second node among the plurality of nodes.

According to another aspect of the present invention, there is provided a management method of a storage system including a plurality of nodes each of which includes a processor, the management method including, when a replication source volume in a replication source storage system connected to the storage system is replicated to the plurality of nodes of the storage system, allowing any one of the processors to generate a first replicated volume by replicating the replication source volume of the replication source storage system in a first node among the plurality of nodes, and generate a second replicated volume mapped to the first replicated volume in a second node among the plurality of nodes.

According to the present invention, the convenience of secondary use of a volume can be improved. Objects, configurations, and effects other than those described above will be clarified by describing the following embodiments.

### BRIEF DESCRIPTION OF THE DRAWINGS

FIG. 1 is an overall configuration diagram illustrating an information processing system according to a first embodiment;

FIG. 2 is a configuration diagram illustrating a storage node according to one embodiment;

FIG. 3 is a configuration diagram illustrating a management device according to one embodiment;

FIG. 4 is a diagram illustrating the summary of a scale-out process of the information processing system according to the first embodiment;

FIG. 5 is a configuration diagram illustrating a memory of the management device according to one embodiment;

FIG. 6 is a configuration diagram illustrating a memory of the storage node according to one embodiment;

FIG. 7 is a configuration diagram illustrating a scale-out management table according to one embodiment;

FIG. 8 is a configuration diagram illustrating a storage node management table according to one embodiment;

FIG. 9 is a configuration diagram illustrating a scale-out target VOL management table according to one embodiment;

FIG. 10 is a configuration diagram illustrating an E-VOL management table according to one embodiment;

FIG. 11 is a configuration diagram illustrating an SS-VOL management table according to one embodiment;

FIG. 12 is a flowchart illustrating an entire scale-out process according to one embodiment;

FIG. 13 is a flowchart illustrating an information check process required for the scale-out according to one embodiment;

FIG. 14 is a flowchart illustrating a VOL for deployment generation process according to one embodiment;

FIG. 15 is a flowchart illustrating an E-VOL generation process according to one embodiment;

FIG. 16 is a flowchart illustrating an SS-VOL generation process according to one embodiment;

FIG. 17 is a flowchart illustrating a path change process according to one embodiment;

FIG. 18 is an overall configuration diagram illustrating information processing systems according to second and third embodiments;

FIG. 19 is a diagram illustrating the summary of a scale-out process of the information processing system according to the second embodiment; and

FIG. 20 is a diagram illustrating the summary of a scale-out process of the information processing system according to the third embodiment.

### DESCRIPTION OF EMBODIMENTS

Embodiments of the present invention will be described with reference to the drawings. The embodiments described below do not limit the present inventions according to the claims, and all the elements described in the embodiments and combinations thereof are not necessarily indispensable for solving means of the invention.

In the following description, information may be described using the expression “AAA table”. However, the information may be expressed using any data structure. That is, to show that the information does not depend on the data structure, “AAA table” will also be referred to as “AAA information”.

In the following description, a process may be described using “program” as a subject of an operation. Here, by executing a program using a processor (for example, CPU), a predetermined process is executed while appropriately using a storage resource (for example, a memory) and/or a communication interface device (for example, a network interface card (NIC)). Therefore, the subject of the process may be the processor. The process described using the program as the subject of the operation may be a process that is executed by a processor or a computer (system) including the processor.

In the following description, two or more programs may be implemented as one program, or one program may be implemented as two or more programs.

In the following description, “VOL” represents a logical volume and may be a logical storage device. VOL may be a substantial volume (volume based on a physical storage device) or may be a virtual volume.

### First Embodiment

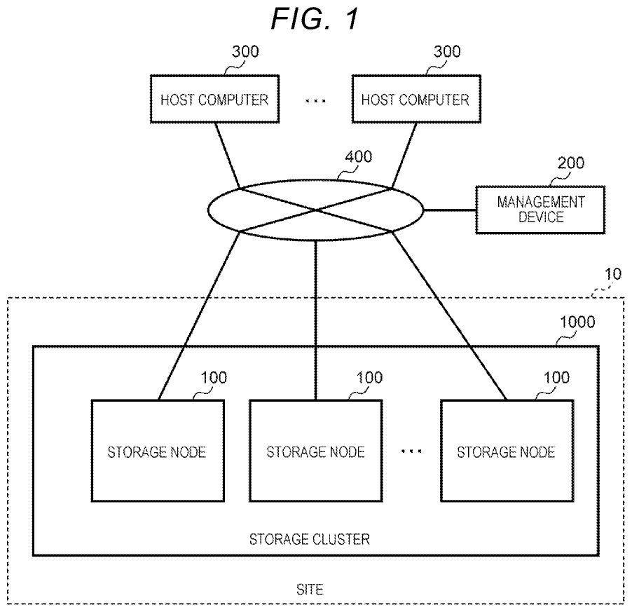

FIG. 1 is an overall configuration diagram illustrating an information processing system according to a first embodiment.

An information processing system 1 includes a storage cluster 1000, a management device 200, and one or more host computers 300. The storage cluster 1000 includes one or more storage nodes 100. The storage cluster 1000 may be called a storage system or a distributed storage system. In the embodiment, the storage cluster 1000 is provided in a site 10. The site 10 may be, for example, on-premises or cloud-based.

The storage nodes 100, the management device 200, and the host computers 300 are connected via a network 400. The network 400 may be, for example, a local area network (LAN) or a wide area network (WAN).

The storage node 100 provides a storage area for reading and writing data into and from the host computer 300. The storage node 100 may be a physical computer or may be a virtual computer.

The management device 200 is a computer that is used by a system manager to manage the entire information processing system 1. The management device 200 may be a physical computer or may be a virtual computer. The management device 200 acquires information from the entire storage cluster 1000, the storage node 100, or the host computer 300 using a program, and displays information via a user interface (a graphical user interface (GUI) or a command line interface (CLI)). The management device 200 has a function of transmitting an instruction input via the user interface from the system manager to the entire storage cluster 1000, the storage node 100, or the host computer 300. The management device 200 may have a function of automatically transmitting an optimum instruction to the storage cluster 1000, the storage node 100, or the host computer 300 based on the information acquired from the storage cluster 1000, the storage node 100, or the host computer 300 without receiving an instruction from the system manager. The management device 200 may be an on-premises device or a cloud-based device. The function of the management device 200 may be implemented by any one of the storage nodes 100.

The host computer 300 transmits a read/write request (hereinafter, appropriately referred to as an input/output (I/O) request) to the storage cluster 1000 in response to a request from a user operation or an application program (for example, a file server program or a database server program). The host computer 300 may be a physical computer or may be a virtual computer. For example, when a plurality of storage nodes 100 configure a cluster, multipaths are set between the host computer 300 and the storage nodes configuring the cluster. For example, when Linux (registered trademark) is used, multipath-tools is used for setting the multipaths. When the host computer 300 is a Windows (registered trademark) server, MPIO service can be used. The host computer 300 may be an on-premises device or a cloud-based device.

Next, the details of the storage node 100 will be described in detail.

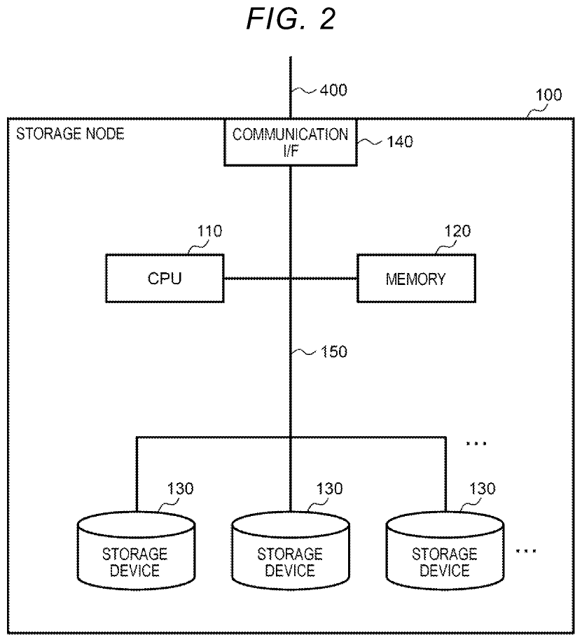

FIG. 2 is a configuration diagram illustrating a storage node according

to one embodiment.

The storage node 100 includes a central processing unit (CPU) 110, a memory 120, a plurality of storage devices 130, and a communication I/F 140 that are connected to each other via an internal network 150. One or more CPUs 110, one or more memories 120, one or more storage devices 130, and one or more communication I/Fs 140 may be provided in each of the storage nodes 100.

The CPU 110 is a processor that controls an overall operation of the storage node 100. The CPU 110 executes various processes based on programs or management information stored in the memory 120. The CPU 110 may be a physical CPU of a physical computer or may be a virtual CPU to which a physical CPU of a physical computer is virtually allocated using a cloud virtualization function.

The memory 120 is configured by a volatile semiconductor memory such as a static random access memory (SRAM) or a dynamic RAM (DRAM), and stores various programs that are executed by the CPU 110 or management information that is referred to or updated by the CPU 110. The memory 120 may be a physical memory or may be a virtual memory to which a physical memory is virtually allocated using a cloud virtualization function.

The storage device 130 stores user data that is used by the host computer 300. Typically, the storage device 130 may be a non-volatile storage device. The storage device 130 may be, for example, a hard disk drive (HDD) or a solid state drive (SSD). The storage device 130 may be a physical storage device or may be a virtual storage device to which a physical storage device is virtually allocated using a cloud virtualization function.

The communication I/F 140 is an interface for allowing the storage node 100 to communicate with the host computer 300, another storage node 100, or the management device 200 via the network 400, and is configured by, for example, a network interface card (NIC) or a fiber channel (FC) card. The communication I/F 140 may be a physical communication I/F or may be a virtual communication I/F to which a physical communication I/F is virtually allocated using a cloud virtualization function.

Next, the management device 200 will be described in detail.

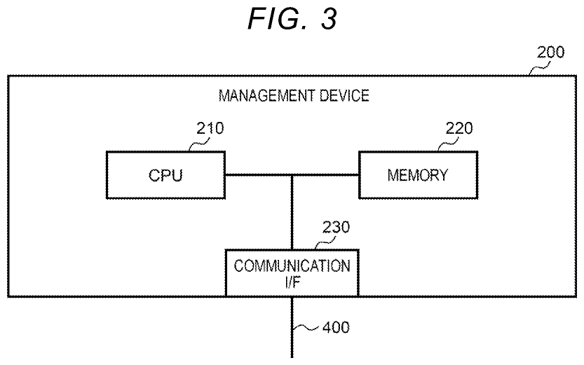

FIG. 3 is a configuration diagram illustrating a management device according to one embodiment.

The management device 200 includes a CPU 210, a memory 220, and a communication I/F 230. The CPU 210 executes a process of controlling the host computer 300, the storage node 100, or the entire storage cluster 1000 based on the programs or the management information stored in the memory 220. The memory 220 stores various programs that are executed by the CPU 210 or management information that is referred to or updated by the CPU 210. The communication I/F 230 is an interface for communicating with the storage node 100 or the host computer 300 via the network 400.

Next, the summary of the scale-out of the information processing system 1 will be described.

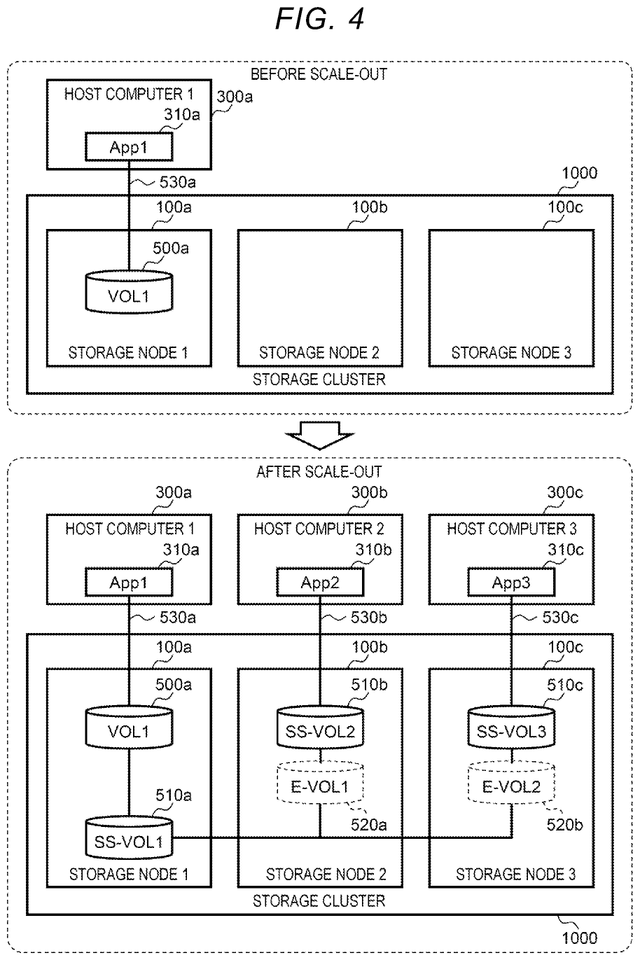

FIG. 4 is a diagram illustrating the summary of a scale-out process of the information processing system according to the first embodiment.

The storage cluster 1000 includes a storage node 100a, a storage node 100b, and a storage node 100c.

Before scale-out, a volume (VOL) 500a is defined in the storage node 100a. In the storage node 100a, a path 530a is defined as a communication path between a host computer 300a and the VOL 500a, and the VOL 500a can be read/written by the host computer 300a. In the host computer 300a, an application program (App) 310a operates. The App 310a implements a function (for example, a business application, a database, or a file server) of the App 310a by referring to/updating data of the VOL 500a.

After scale-out, in the storage node 100a, the VOL 500a and a snapshot volume (SS-VOL) 510a that is provided as a snapshot of the VOL 500a are defined. In the storage node 100a, the path 530a between the host computer 300a and the VOL 500a is defined, and the App 310a that operates in the host computer 300a can refer to/update the data of the VOL 500a.

In the storage node 100b, an external connection volume 520a (E-VOL) that is provided by external connection of the SS-VOL 510a and an SS-VOL 510b that is provided as a snapshot of the E-VOL 520a are defined. In the storage node 100b, a path 530b between a host computer 300b and the SS-VOL 510b is defined, and an App 310b that operates in the host computer 300b can refer to/update the data of the SS-VOL 510b.

In the storage node 100c, an E-VOL 520b that is provided by external connection of the SS-VOL 510a and an SS-VOL 510c that is provided as a snapshot of the E-VOL 520b are defined. In the storage node 100c, a path 530c between a host computer 300c and the SS-VOL 510c is defined, and an App 310c that operates in the host computer 300c can refer to/update the data of the SS-VOL 510c.

The external connection is a function of allowing a second storage node (in the example illustrated in FIG. 4, the storage node 100b and the storage node 100c) connected to a first storage node (in the example illustrated in FIG. 4, the storage node 100a) to associate (map) a volume (in the example illustrated in FIG. 4, the SS-VOL 510a) provided by the first storage node as a virtual volume (in the example illustrated in FIG. 4, the E-VOL 520a and the E-VOL 520b) provided by the second storage node. The mapping refers to allocating a management number required for an operation from the second storage node to the E-VOL. By mapping the E-VOL, the second storage node can execute the same management operation (for example, a management from a GUI or a CLI, or application of a function such as a snapshot or remote replication) as the volume generated by the second storage node itself on the E-VOL. When a read/write request for the E-VOL provided by the second storage node is received from the host computer or the volume based on the E-VOL, the second storage node can transmit the read/write request to the VOL in the first storage node corresponding to the E-VOL.

As a result, even when the second storage node desires to provide a volume having the same data as the VOL in the first storage node, the second storage node does not need to define a VOL having the same type as the VOL in the first storage node and to provide a storage device required for the definition or the capacity of a capacity virtualization technique (for example, thin provisioning). When a read/write request for the E-VOL provided by the second storage node is received, only a data block corresponding to the read/write request for the E-VOL may be transmitted between the first storage node and the second storage node in response to the read/write request. Therefore, by using the external connection function, when the second storage node provides a volume having the same data as the VOL in the first storage node, the full data in the VOL in the first storage node does not need to be transmitted to the second storage node at the provision start time, and the second storage node can receive the read/write request for the E-VOL from a host computer or a volume based on the E-VOL when the setting of the external connection is completed.

When the second storage node provides the E-VOL, a cache may be prepared in the second storage node that provides the E-VOL such that a data block of the VOL corresponding to the E-VOL transmitted from the first storage node is stored in the cache and the cached data block is referred to/updated in response to the read/write request from the host computer or the volume based on the E-VOL that transmits the read/write request. The cache may be typically implemented by the memory 120.

The SS-VOL may be a volume that is provided as a replication of a snapshot target volume, or may store only difference data (snapshot data) in a storage device or in a storage area (typically, a pool) configured by a plurality of storage devices, in which the difference data is generated according to update by a writing operation on the SS-VOL and the snapshot target volume.

Next, a configuration of the memory 220 of the management device 200 will be described.

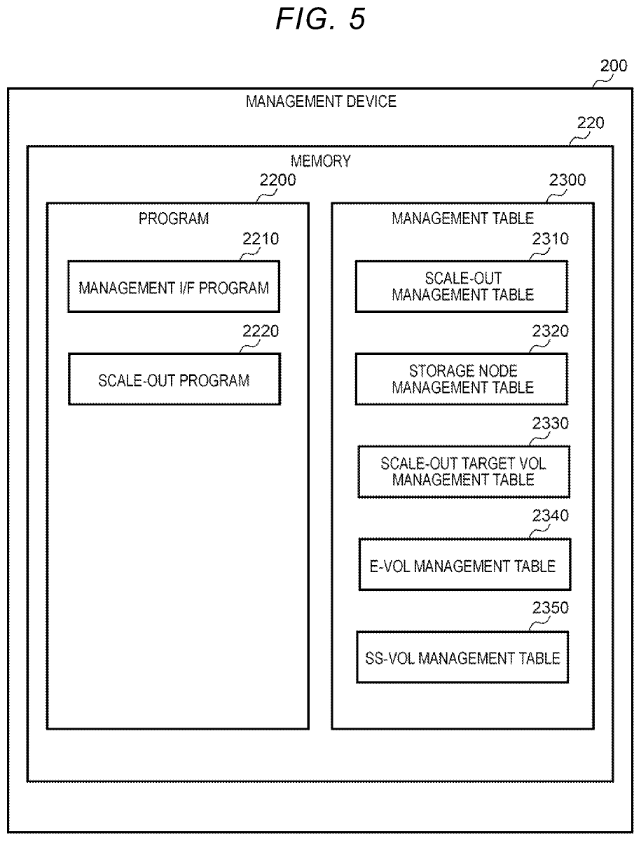

FIG. 5 is a configuration diagram illustrating a memory of the management device according to the embodiment.

The memory 220 of the management device 200 stores a program 2200 and a management table 2300.

The program 2200 includes a management I/F program 2210 and a scale-out program 2220. The management I/F program 2210 is a program for delivering an instruction content transmitted from a management client that is operated by the manager of the information processing system 1 to a program that executes a process corresponding to the instruction content, and for transmitting the execution result of the program that executes the process corresponding to the instruction content to the management client of the information processing system 1. The scale-out program 2220 is a program for executing the scale-out process based on the scale-out instruction content from the management client.

The management table 2300 includes a scale-out management table 2310, a storage node management table 2320, a scale-out target VOL management table 2330, an E-VOL management table 2340, and an SS-VOL management table 2350. The scale-out management table 2310 is information for managing the scale-out instruction content from the management client and the current state of the scale-out process. The storage node management table 2320 is information for managing the current states of the storage nodes 100 in the storage cluster 1000. The scale-out target VOL management table 2330 is information for managing a VOL 500 that is a scale-out target in the scale-out process. The E-VOL management table 2340 is information for managing an E-VOL 520 that is generated in the scale-out process. The SS-VOL management table 2350 is information for managing an SS-VOL 510 that is generated in the scale-out process.

Next, the configuration of the memory 120 of the storage node 100 will be described.

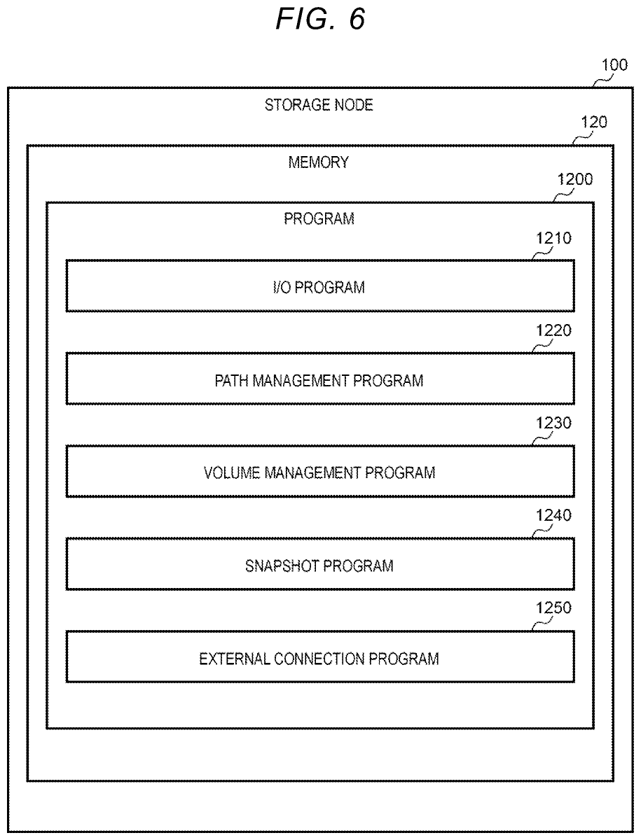

FIG. 6 is a configuration diagram illustrating a memory of the storage node according to the embodiment.

The memory 120 of the storage node 100 stores a program 1200.

The program 1200 includes an I/O program 1210, a path management program 1220, a volume management program 1230, a snapshot program 1240, and an external connection program 1250. The I/O program 1210 is a program for processing an I/O request from the host computer 300. The path management program 1220 is a program for generating and deleting a path, managing path information, and executing a path control between the host computer 300 and the volume based on path definition. The volume management program 1230 is a program for generating and deleting a volume and managing volume information. The snapshot program 1240 is a program for generating and deleting an SS-VOL, managing SS-VOL information, and executing data processing during a reading/writing operation on an SS-VOL. The external connection program 1250 is a program for generating and deleting an E-VOL, managing E-VOL information, and executing data processing during a reading/writing operation on an E-VOL.

Next, the scale-out management table 2310 will be described.

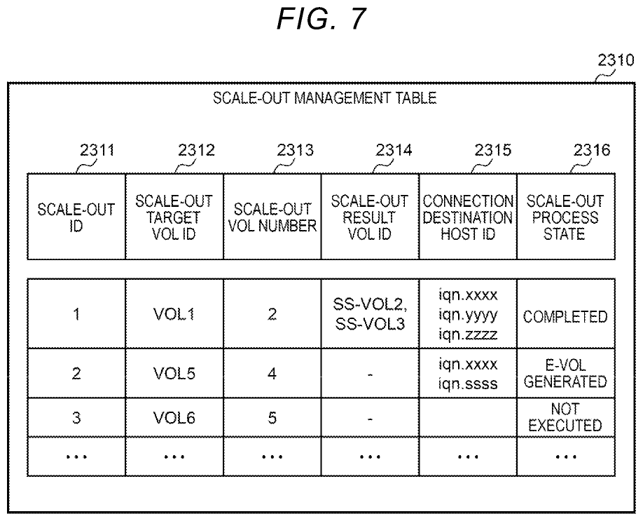

FIG. 7 is a configuration diagram illustrating a scale-out management table according to one embodiment.

The scale-out management table 2310 is a table for managing the information regarding the scale-out instruction content and the current state of the scale-out process. The scale-out management table 2310 stores an entry for each scale-out process. The entry of the scale-out management table 2310 includes fields of a scale-out ID 2311, a scale-out target VOL ID 2312, a scale-out VOL number 2313, a scale-out result VOL ID 2314, a connection destination host ID 2315, and a scale-out process state 2316.

The scale-out ID 2311 stores an identification number of the scale-out process corresponding to the entry. The scale-out target VOL ID 2312 stores an identification number of the scale-out target VOL 500 (VOL ID) in the scale-out process corresponding to the entry. The scale-out VOL number 2313 stores the number of replications required for the scale-out target VOL 500 that is instructed in the scale-out process corresponding to the entry. The scale-out result VOL ID 2314 stores an identification number of the SS-VOL 510 (SS-VOL ID) that is generated in the scale-out process corresponding to the entry. The connection destination host ID 2315 stores a host identification number for path definition with a scale-out result VOL that is instructed in the scale-out process corresponding to the entry. The connection destination host ID is typically a WWN or ISCSI initiator name. The scale-out process state 2316 stores the current state of the scale-out process corresponding to the entry. The scale-out process state may store the progress state of the scale-out process, for example, “Completed”, “E-VOL Generated”, or “Not Executed” and may update the scale-out process state 2316 after executing each process in a flowchart described below.

Next, the storage node management table 2320 will be described.

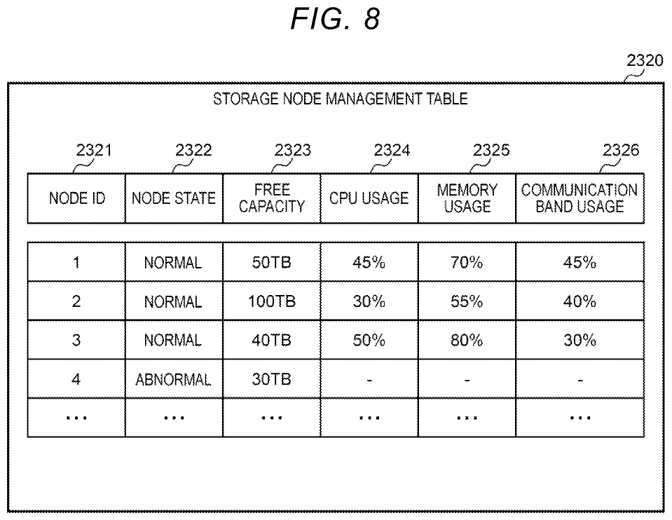

FIG. 8 is a configuration diagram illustrating a storage node management table according to one embodiment.

The storage node management table 2320 is a table for managing the information regarding the current states of the storage nodes 100 in the storage cluster 1000. The storage node management table 2320 stores an entry for each of the storage nodes 100. The entry of the storage node management table 2320 includes fields of a node ID 2321, a node state 2322, a free capacity 2323, a CPU usage 2324, a memory usage 2325, and a communication band usage 2326.

The node ID 2321 stores an identification number of the storage node 100 (node ID) corresponding to the entry. The node state 2322 stores the state of the storage node 100 corresponding to the entry. The node state 2322 may be, for example, information such as “Normal” or “Abnormal”. The free capacity 2323 stores the total free capacity of the storage devices 130 of the storage node 100 corresponding to the entry. The CPU usage 2324 stores the usage of the CPU 110 of the storage node 100 corresponding to the entry. The memory usage 2325 stores the usage of the memory 120 of the storage node 100 corresponding to the entry. The communication band usage 2326 stores the usage of the communication band in the communication I/F 140 of the storage node 100 corresponding to the entry.

Next, the scale-out target VOL management table 2330 will be described.

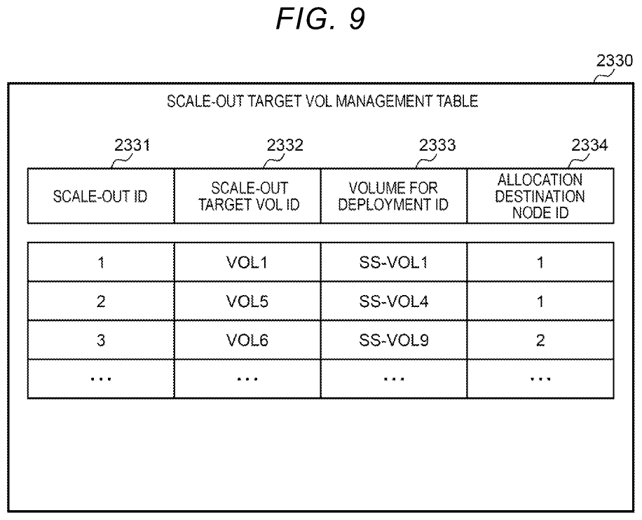

FIG. 9 is a configuration diagram illustrating a scale-out target VOL management table according to one embodiment.

The scale-out target VOL management table 2330 is a table for managing information regarding a scale-out target VOL in the scale-out process. The scale-out target VOL management table 2330 stores an entry for each scale-out process. The entry of the scale-out target VOL management table 2330 includes fields of a scale-out ID 2331, a scale-out target VOL ID 2332, a volume for deployment ID 2333, and an allocation destination node ID 2334.

The scale-out ID 2331 stores an identification number of the scale-out process corresponding to the entry. The scale-out target VOL ID 2332 stores an identification number of the scale-out target VOL 500 (VOL ID) in the scale-out process corresponding to the entry. The volume for deployment ID 2333 stores an identification number of a volume that is used as a volume for deployment in the scale-out process corresponding to the entry. For example, the volume for deployment ID 2333 stores a volume ID (SS-VOL ID) that is used as the external connection destination of the E-VOL 520. The allocation destination node ID 2334 stores an identification number of a node (node ID) where the scale-out target VOL is allocated in the scale-out process corresponding to the entry.

Next, the E-VOL management table 2340 will be described.

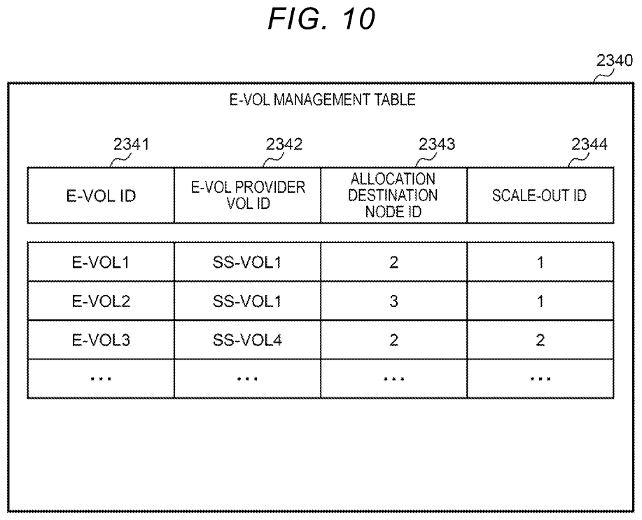

FIG. 10 is a configuration diagram illustrating an E-VOL management table according to one embodiment.

The E-VOL management table 2340 is a table for managing information regarding the E-VOL 520 that is generated in the scale-out process. The E-VOL management table 2340 stores an entry for each of the E-VOLs 520. The entry of the E-VOL management table 2340 includes fields of an E-VOL ID 2341, an E-VOL provider VOL ID 2342, an allocation destination node ID 2343, and a scale-out ID 2344.

The E-VOL ID 2341 stores an identification number of the E-VOL 520 (E-VOL ID) corresponding to the entry. The E-VOL provider VOL ID 2342 stores an identification number (SS-VOL ID) of a volume to which the E-VOL 520 corresponding to the entry is externally connected. The allocation destination node ID 2343 stores an identification number of the storage node 100 (node ID) as an allocation destination of the E-VOL 520 corresponding to the entry. The scale-out ID 2344 stores an identification number of the scale-out process (scale-out ID) in which the E-VOL 520 corresponding to the entry is generated.

Next, the SS-VOL management table 2350 will be described.

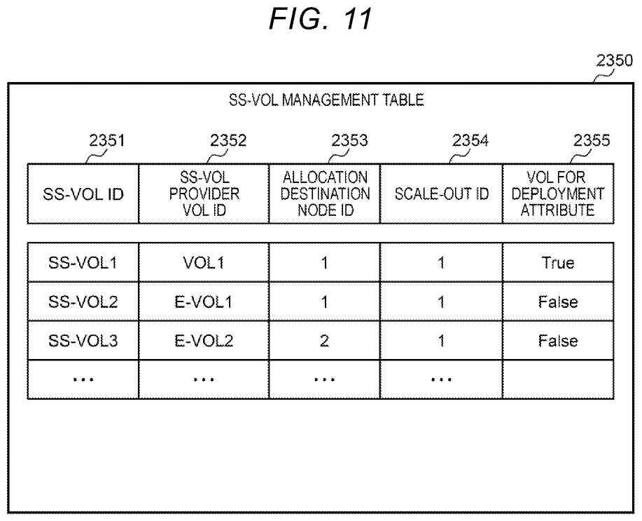

FIG. 11 is a configuration diagram illustrating an SS-VOL management table according to one embodiment.

The SS-VOL management table 2350 is a table for managing information regarding the SS-VOL 510 that is generated in the scale-out process. The SS-VOL management table 2350 stores an entry for each of the SS-VOLs 510. The entry of the SS-VOL management table 2350 includes fields of an SS-VOL ID 2351, an SS-VOL provider VOL ID 2352, an allocation destination node ID 2353, a scale-out ID 2354, and a VOL for deployment attribute 2355.

The SS-VOL ID 2351 stores an identification number of the SS-VOL 510 (SS-VOL ID) corresponding to the entry. The SS-VOL provider VOL ID 2352 stores an identification number of a volume as a snapshot source of the SS-VOL 510 corresponding to the entry. The SS-VOL provider VOL ID 2352 may be, for example, an identification number of the VOL 500 (VOL ID) or an identification number of the E-VOL 520 (E-VOL ID). The allocation destination node ID 2353 stores an identification number of the storage node 100 (node ID) as an allocation destination of the SS-VOL 510 corresponding to the entry. The scale-out ID 2354 stores an identification number of the scale-out process (scale-out ID) in which the SS-VOL 510 corresponding to the entry is generated. The VOL for deployment attribute 2355 stores information regarding an attribute for identifying whether the SS-VOL 510 corresponding to the entry is the SS-VOL 510 that is generated for external connection to another node. In the embodiment, when the SS-VOL 510 corresponding to the entry is the SS-VOL 510 that is generated for external connection to another node, True is stored. When the SS-VOL 510 corresponding to the entry is the SS-VOL 510 that is generated for connection from the host, False is stored.

Next, the flow of the entire scale-out process by the management device 200 will be described.

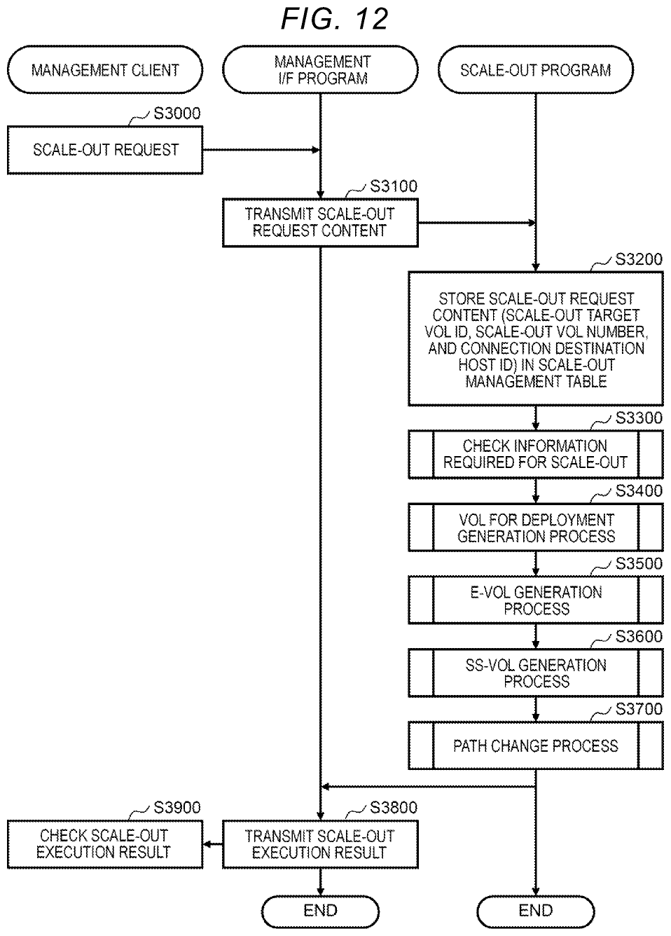

FIG. 12 is a flowchart illustrating an entire scale-out process according to one embodiment.

In the embodiment, the scale-out process is executed in response to a request from the management client of the information processing system 1 as a trigger. However, the scale-out process may be executed in response to another trigger. For example, the management device 200 may regularly collect and analyze operating information of the storage node 100, and when the I/O performance of a volume 500 of the storage node 100 does not reach a preset performance required by a customer, the management device 200 itself may determine necessity of the scale-out, and the management device 200 may automatically issue a trigger of the scale-out process.

The management client of the information processing system 1 transmits a scale-out request to the management I/F program 2210 of the management device 200 (Step S3000). Here, the management client transmits the scale-out target VOL ID, the scale-out VOL number, the connection destination host ID, and the like as input parameters. The connection destination host ID is a parameter used for path setting in the scale-out process but is not necessarily transmitted. After the scale-out process, a path for the connection destination host ID may be set by an operation of the management client itself. The input parameters are not limited to the above-described parameters, and other input parameters may be adopted. For example, a scale-out process execution time may be transmitted as an input parameter, and a scale-out program may control a scale-out execution timing based on the parameter of the scale-out process execution time. The scale-out request may be transmitted by executing input or communication once or by executing input or communication multiple times.

Next, the management I/F program 2210 receives the scale-out request transmitted from the management client, and transmits the content to the scale-out program 2220 (Step S3100). The scale-out request content may be transmitted by executing communication once or by executing communication multiple times.

Next, the scale-out program 2220 receives the scale-out request content transmitted from the management I/F program 2210, and stores the scale-out request content (the scale-out target VOL ID, the scale-out VOL number, and the connection destination host ID) in the scale-out management table 2310 (Step S3200). Here, the scale-out program 2220 numbers the scale-out ID to not overlap the scale-out IDs of the entry that are previously stored in the scale-out management table 2310, and stores the scale-out request content in the scale-out management table 2310.

The scale-out program 2220 collects and checks information required for the scale-out process based on the scale-out request content stored in the scale-out management table 2310 (Step S3300). Here, the information of the scale-out target VOL and the storage node 100 required for the determination of the scale-out process are acquired and stored in the management table.

Next, the scale-out program 2220 executes a VOL for deployment generation process (Step S3400). Here, the nodes other than the allocation destination node of the scale-out target VOL generate a VOL for deployment that functions as an external connection destination during the generation of the E-VOL 520. Next, the scale-out program 2220 executes an E-VOL generation process (Step S3500). Here, the E-VOL 520 that is externally connected to the VOL for deployment generated by the VOL for deployment generation process is generated.

Next, the scale-out program 2220 executes an SS-VOL generation process (Step S3600). Here, the VOL for deployment that is generated in the VOL for deployment generation process (Step S3400) or the E-VOL 520 that is generated in the E-VOL generation process (Step S3500) is used as a snapshot source to generate the SS-VOL 510.

Next, the scale-out program 2220 executes a path change process S3700. Here, a path between the SS-VOL 510 that is generated in the SS-VOL generation process (Step S3600) and the host represented by the connection destination host ID that is stored in the scale-out management table 2310 in the scale-out request content storage process (Step S3200) is generated. After completing the process of Step S3200 to Step S3700, the scale-out program 2220 notifies the completion and the result of the scale-out process to the management I/F program.

Next, the management I/F program 2210 transmits the execution result notified from the scale-out program 2220 to the management client (Step S3800). A method of transmitting the execution result is not particularly limited, and the execution result may be transmitted by displaying a screen via a GUI or as a command response via a CLI or an API.

Finally, the management client checks the scale-out execution result transmitted by the management I/F program 2210 (Step S3900). Here, the management client can check whether the scale-out is successful and information regarding the volume ID replicated as the scale-out result, the number, the allocation destination node ID, and the like.

Next, the information check process (Step S3300) required for the scale-

out will be described in detail.

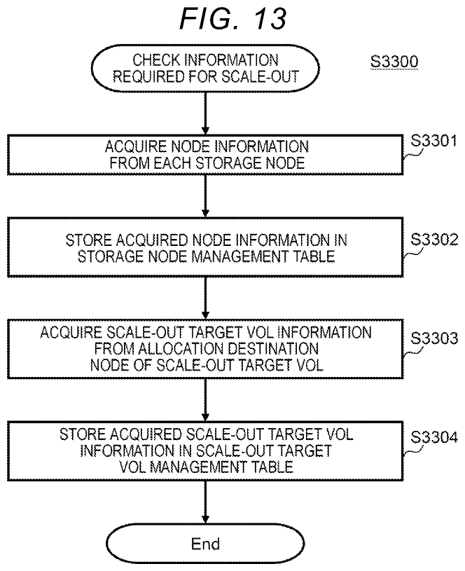

FIG. 13 is a flowchart illustrating an information check process required for the scale-out according to one embodiment.

The scale-out program 2220 of the management device 200 acquires node information from each of the storage nodes 100 (Step S3301). Here, the acquired node information is the field information of the storage node management table 2320. The scale-out program 2220 stores the acquired node information in the storage node management table 2320 (Step S3302). The processes of Steps S3301 to S3302 may be executed regularly in response to a trigger other than the scale-out process. When the latest information of the storage node information is regularly stored in the storage node management table 2320, Steps S3301 to S3302 do not need to be executed in the flow of the scale-out process.

Next, the scale-out program 2220 acquires scale-out target VOL information from the allocation destination node of the scale-out target VOL (Step S3303). As a method in which the management device 200 grasps the allocation destination node of the scale-out target VOL, at a timing at which the target VOL is generated in the operation management before the scale-out process, the volume information and the allocation destination node information may be associated with each other and stored in the management table of the management device 200 in advance, or the management device 200 may inquire each of the storage nodes 100 for whether the target VOL is allocated in the node. The scale-out program 2220 stores the acquired scale-out target VOL information in the scale-out target VOL management table 2330 (Step S3304). Here, as the scale-out ID, the ID numbered in Step S3200 is stored. Here, the field of the volume for deployment ID 2333 may not store information.

Next, the VOL for deployment generation process (Step S3400) will be described in detail.

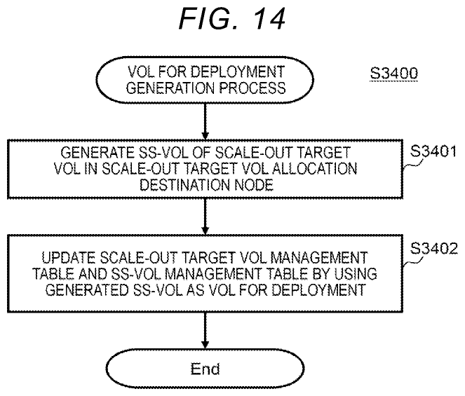

FIG. 14 is a flowchart illustrating a VOL for deployment generation process according to one embodiment.

The scale-out program 2220 of the management device 200 generates the SS-VOL 510 of the scale-out target VOL 500 in the scale-out target VOL allocation destination node checked in Step S3303 (Step S3401). Specifically, the management device 200 transmits an SS-VOL generation request to the scale-out target VOL allocation destination node by using the scale-out target VOL 500 as a snapshot source, and the snapshot program 1240 of the storage node 100 that received the SS-VOL generation request generates the SS-VOL 510 by using the scale-out target VOL 500 as a snapshot source and transmits the result (for example, whether the SS-VOL generation is successful or the SS-VOL ID) to the management device 200.

Next, the scale-out program 2220 updates the scale-out target VOL management table 2330 to set the SS-VOL 510 generated in Step S3401 as the VOL for deployment. Specifically, the ID of the SS-VOL 510 is stored in the volume for deployment ID field 2333 of the entry stored in Step S3304. The SS-VOL management table 2350 is updated. Specifically, the ID of the SS-VOL 510 generated in Step S3401 is stored in the SS-VOL ID 2351, the ID of the scale-out target VOL 500 is stored in the SS-VOL provider VOL ID 2352, the SS-VOL 510 generation destination node is stored in the allocation destination node ID 2353, the scale-out ID numbered in Step S3200 is stored in the scale-out ID 2354, and True is stored in the VOL for deployment attribute (Step S3402).

Next, the E-VOL generation process (Step S3500) will be described in detail.

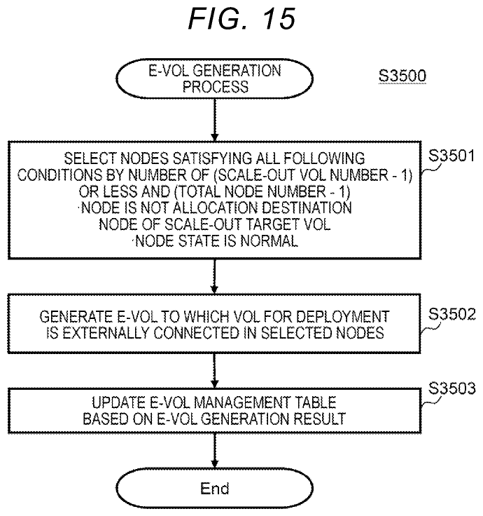

FIG. 15 is a flowchart illustrating an E-VOL generation process according to one embodiment.

The scale-out program 2220 of the management device 200 selects the storage nodes 100 satisfying conditions “the storage node 100 is not the allocation destination node of the scale-out target VOL” and “the node state is normal” by the number of (the scale-out VOL number-1) or less and (the total node number-1) (Step S3501). Whether the storage node 100 is the allocation destination node of the scale-out target VOL can be determined by comparing the allocation destination node ID 2334 of the scale-out target VOL management table 2330 and the node ID of the storage node 100 to each other. Whether the node state is normal may be determined by referring to the node state 2322 of the storage node management table 2320. The scale-out VOL number may be determined by referring to the scale-out VOL number 2313 of the scale-out management table 2310. The total node number may be checked, for example, by counting the number of valid entries in the storage node management table 2320, or another management table may be prepared to manage the total node number therein.

Next, the scale-out program 2220 generates the E-VOL 520 that is externally connected to the VOL for deployment (SS-VOL 510) in the storage nodes 100 selected in Step S3501 (Step S3502). Specifically, the management device 200 transmits an E-VOL generation request for external connection to the VOL for deployment (SS-VOL 510) generated in S3401 to the storage nodes 100 selected in Step S3501, and the external connection program 1250 of the storage node 100 that received the E-VOL generation request generates the E-VOL 520 that is externally connected to the VOL for deployment (SS-VOL 510), and transmits the result (for example, whether the E-VOL generation is successful or the E-VOL ID) to the management device 200.

The E-VOL management table 2340 is updated based on the E-VOL generation result in Step S3502 (Step S3503). Specifically, the ID of the E-VOL 520 generated in Step S3502 is stored in the E-VOL ID 2341, the ID of the volume as the snapshot source of the E-VOL 520 generated in Step S3502 is stored in the E-VOL provider VOL ID 2342, the node ID of the storage node 100 as the generation destination of the E-VOL 520 that is generated in Step S3502 is stored in the allocation destination node ID 2343, and the scale-out ID numbered in Step S3200 is stored in the scale-out ID 2344.

Next, the SS-VOL generation process (Step S3600) will be described in detail.

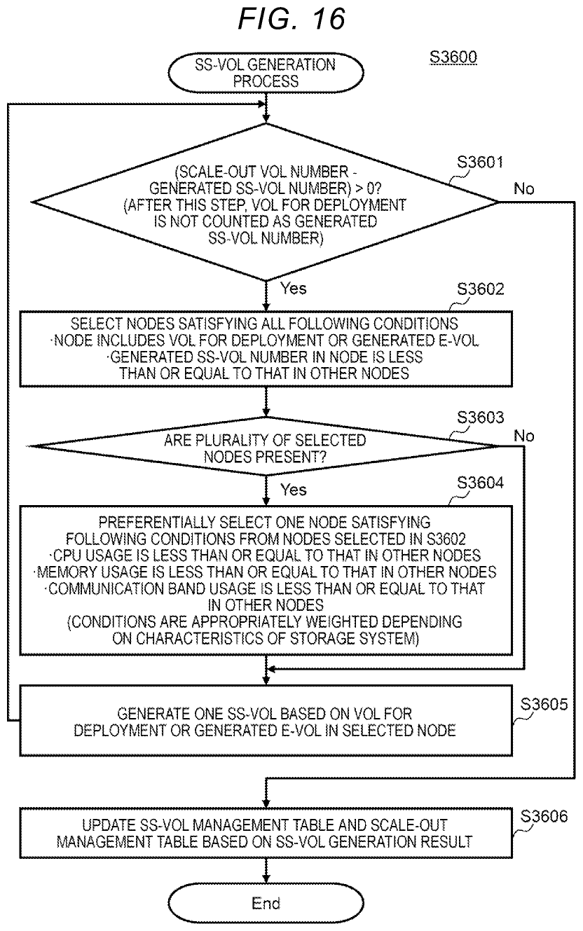

FIG. 16 is a flowchart illustrating an SS-VOL generation process according to one embodiment.

The scale-out program 2220 of the management device 200 determines whether “(the scale-out VOL number-the number of generated SS-VOLs other than the SS-VOL generated as the VOL for deployment) >0 is satisfied. When the condition is satisfied, the process proceeds to Step S3602. When the condition is not satisfied, the process proceeds to Step S3606 (Step S3601). In Step S3601, specifically, the scale-out program 2220 determines whether the number of generated SS-VOLs 510 other than the SS-VOL generated as the VOL for deployment reaches the scale-out VOL number. The scale-out VOL number may be determined by referring to the scale-out VOL number 2313 of the scale-out management table 2310. The number of generated SS-VOLs 510 other than the SS-VOL generated as the VOL for deployment may be determined by counting the number of entries where the scale-out ID 2354 of the SS-VOL management table 2350 is the scale-out ID numbered in Step S3200 and the VOL for deployment attribute 2355 is False.

When (the scale-out VOL number-the number of generated SS-VOLs other than the SS-VOL generated as the VOL for deployment) >0 is satisfied (Step S3601: Yes), the scale-out program 2220 selects the storage nodes 100 satisfying conditions “the storage node has the VOL for deployment or the generated E-VOL” and “the generated SS-VOL number is less than or equal to that in the other nodes” (Step S3602). Step S3602 is executed to allocate the SS-VOL 520 that is provided to the host computer 300 to each of the storage nodes 100 as uniformly as possible in the scale-out process. Whether the storage node 100 has the VOL for deployment may be determined by referring to the scale-out target VOL management table 2330. Whether the storage node 100 has the generated E-VOL may be determined by referring to the E-VOL management table 2340. Whether the generated SS-VOL number in the node is less than or equal to that in the other nodes may be determined by referring to the SS-VOL management table 2350.

The scale-out program 2220 determines whether the number of the storage nodes 100 selected in Step S3602 is plural (Step S3603). When the condition is satisfied, the process proceeds to Step S3604. When the condition is not satisfied, the process proceeds to Step S3605. When a plurality of storage nodes are selected in Step S3602, the scale-out program 2220 selects one storage node 100 based on the information of the storage nodes 100 (Step S3604). Specifically, by referring to the CPU usage 2324, the memory usage 2325, and the communication band usage 2326 of the storage node management table 2320, the scale-out program 2220 preferentially selects one storage node 100 where the usages are less than those in the other storage nodes 100. Here, which one of the usages of the resources of the storage node 100 is weighted may be appropriately determined depending on the characteristics of the storage system or the current usage state of the storage system.

The scale-out program 2220 generates one SS-VOL 510 based on the VOL for deployment or the generated E-VOL in the storage node 100 selected in Step S3604 or Step S3602 (Step S3605). Specifically, when the scale-out program 2220 checks that the VOL for deployment is allocated in the selected storage node 100 by referring to the scale-out target VOL management table 2330, the scale-out program 2220 generates the SS-VOL 510 based on the VOL for deployment. When the scale-out program 2220 checks that the E-VOL 520 is allocated in the selected storage node 100 by referring to the E-VOL management table 2340, the scale-out program 2220 generates the SS-VOL 510 based on the E-VOL 520. In the SS-VOL generation process, the management device 200 transmits an SS-VOL generation request to the selected storage node 100 by setting a snapshot generation source VOL ID and one generation number as parameters, the snapshot program 1240 of the storage node 100 that received the SS-VOL generation request generates one SS-VOL 510 based on the VOL designated by the snapshot generation source VOL ID, and transmits the result (for example, whether the SS-VOL generation is successful or the SS-VOL ID) to the management device 200.

Next, the scale-out program 2220 returns to Step S3601, and determines whether the SS-VOL 520 is generated by the number required for the scale-out again.

By repeating Steps S3601 to S3605, the scale-out program 2220 generates the SS-VOL 520 by the scale-out VOL number designated by the scale-out request. After generating the SS-VOL 520 by the scale-out VOL number designated by the scale-out request (Step S3601; No), the scale-out program 2220 proceeds Step S3606, and updates the SS-VOL management table 2350 based on the generation result of the SS-VOL 520 in Step S3605 (Step S3606). Specifically, the ID of the SS-VOL 520 generated in Step S3605 is stored in the SS-VOL ID 2351, the ID of the volume as the snapshot source of the SS-VOL 520 generated in Step S3605 is stored in the SS-VOL provider VOL ID 2352, the node ID of the storage node 100 as the generation destination of the SS-VOL 520 that is generated in Step S3605 is stored in the allocation destination node ID 2353, the scale-out ID numbered in Step S3200 is stored in the scale-out ID 2354, and False is stored in the VOL for deployment attribute 2355. As in the embodiment, the process of Step S3606 may be collectively executed after exiting the loop of Steps S3601 to S3605. As another method, for example, the process of Step S3606 may be executed every time after executing Step S3605.

In FIG. 16, uniform distribution of the load is implemented by preferentially generating the SS-VOL 510 in the node having a low load. The node that generates the SS-VOL 510 may also be selected depending on the performance or the use of the node. For example, a node having a high performance and having a margin in the process may be selected, or a node used for an application where a high performance is not required may be selected.

Next, the path change process (Step S3700) will be described in detail.

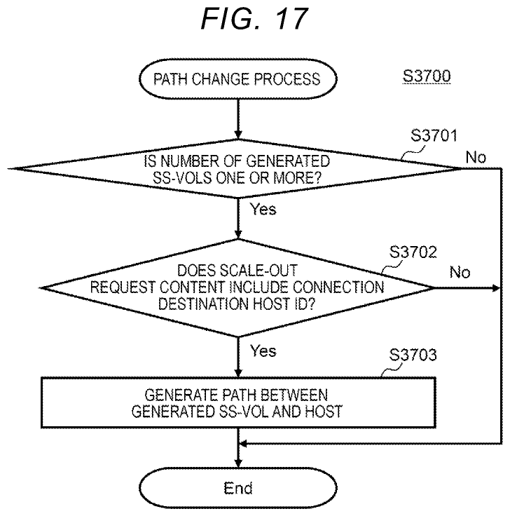

FIG. 17 is a flowchart illustrating a path change process according to one embodiment.

The scale-out program 2220 of the management device 200 determines whether the number of the SS-VOLs 520 generated in step S3600 is one or more (Step S3701). The number of the SS-VOLs 520 may be determined by counting the number of entries where the scale-out ID 2354 of the SS-VOL management table 2350 is the scale-out ID numbered in Step S3200 and the VOL for deployment attribute 2355 is False. When the condition of Step S3701 is satisfied, the process proceeds to Step S3702. When the condition is not satisfied, the path change process S3700 ends.

When the process proceeds to Step S3702, the scale-out program 2220 determines whether the scale-out request content includes the connection destination host ID by referring to the connection destination host ID 2315 of the scale-out management table 2310. When the condition of Step S3702 is satisfied, the process proceeds to Step S3703. When the condition is not satisfied, the path change process S3700 ends.

When the process proceeds to Step S3703, a path 530 is generated such that each of the SS-VOLs 520 generated in Step S3600 and each of the host computers 300 represented by the connection destination host ID 2315 stored in the scale-out management table 2310 in Step S3200 have a one-to-one correspondence. Specifically, the management device 200 transmits a path generation request to the storage node 100 by setting the ID of the SS-VOL 520 generated in Step S3600 and the connection destination host ID 2315 stored in the scale-out management table 2310 as parameters, and the path management program 1220 in the storage node 100 that received the path generation request generates a path between the SS-VOL 520 and the host computer 300 designated as the parameter, and transmits the result (whether the path generation process is successful, a path ID, and a volume identification number (typically, LUN ID) when the host computer 300 accesses the volume via the path 530) to the management device 200.

In the embodiment described above, the SS-VOL 510a is generated based on the VOL 500 in the storage node 100, the storage node 100 other than the storage node 100 where the VOL 500 is allocated generates the E-VOL 520 that is externally connected to the SS-VOL 510a, generates the SS-VOL 510b based on the SS-VOL 510a or the E-VOL 520, and generates a path between the generated SS-VOL 510b and the host computer 300. As a result, the replications of the VOL 500 can be provided to the plurality of host computers 300 from the plurality of storage nodes 100. Accordingly, when the VOL 500 in the storage node 100 is scaled out to the other storage nodes 100, a period of time required to fully copy the data in the VOL 500 to the other storage nodes 100 is unnecessary, and can be instantly scaled out.

### Second Embodiment

In the first embodiment, the VOL 500 of the storage cluster 1000 in one site 10 is scaled out in the storage cluster 1000. In a second embodiment, the VOL 500 is scaled out in a hybrid cloud environment. Specifically, the VOL 500 in an on-premises storage system is scaled out in a cloud-based storage cluster 1000.

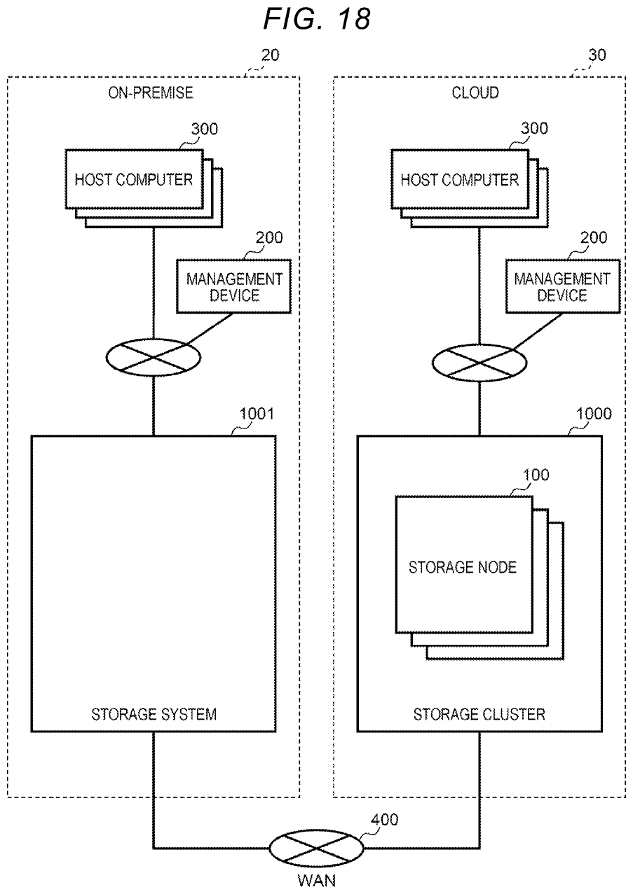

FIG. 18 is an overall configuration diagram illustrating information processing systems according to second and third embodiments.

As illustrated in FIG. 18, the second and third embodiments relate to an information processing system in a hybrid cloud environment including an on-premises site 20 and a cloud site 30, not the information processing system in one site illustrated in FIG. 1. A storage system 1001 in the on-premises site 20 may be a cluster system such as the storage cluster 1000 where the plurality of storage nodes 100 are clustered and connected to each other via a LAN or a WAN, or may be another storage system (for example, a closely coupled redundant storage system to which a plurality of storage controllers are connected via a high-speed communication I/F (PCle or the like) and has a shared memory). The storage system 1001 and the storage cluster 1000 are connected via a WAN 400. The management device 200 may be provided in each of the on-premises site 20 and the cloud site 30, or may be not provided in either the one-premises site 20 or the cloud site 30, but provided across sites of the on-premises site 20 and the cloud site 30 to be capable of managing the storage system 1001 or the storage cluster 1000.

Next, the summary of the scale-out of the information processing system according to the second embodiment will be described.

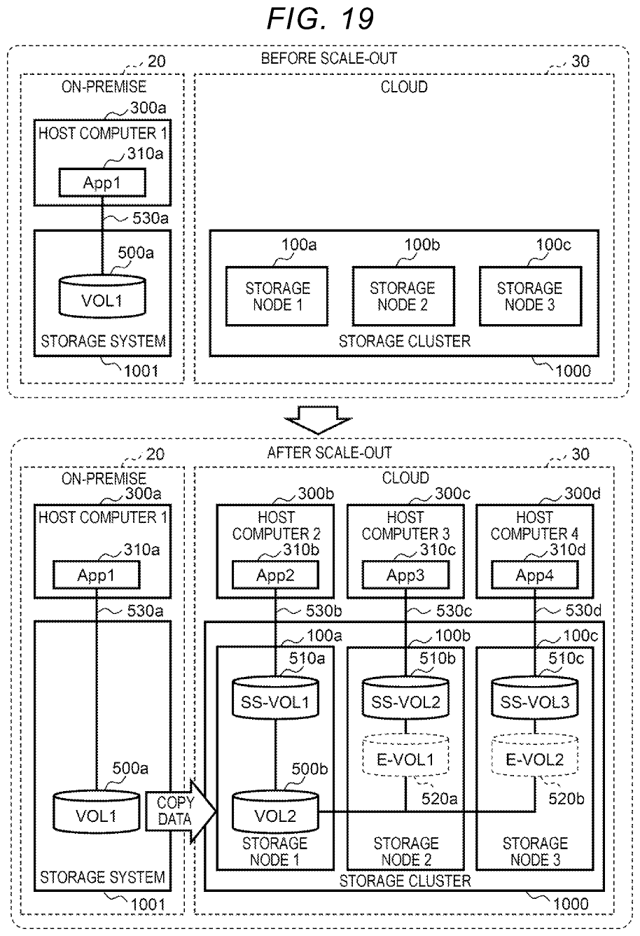

FIG. 19 is a diagram illustrating the summary of a scale-out process of the information processing system according to the second embodiment.

Before the scale-out, the path 530a is defined between the VOL 500a in the storage system 1001 of the on-premises site 20 and the host computer 300a, and the App 310a can read/write data of the VOL 500a. The storage cluster 1000 is provided in the cloud site 30.

After the scale-out, a VOL 500b that is generated by copying data from the storage system 1001 is allocated in the storage node 100a of the storage cluster 1000. The VOL 500b is deployed as the scale-out target VOL by the scale-out process in each of the storage nodes and is finally provided to the host computers as the SS-VOL 510a, the SS-VOL 510b, and the SS-VOL 510c. As the scale-out process, the scale-out process described in the first embodiment may be executed by using the VOL 500b as the scale-out target VOL. Note that, when the scale-out target VOL 500b does not form a path with any host computer and has no possibility of the I/O process after being copied from the on-premises site 20, as illustrated in FIG. 19, the SS-VOL 510 does not need to be generated as a snapshot of the VOL 500b to be provided as the VOL for deployment. The VOL 500b may be directly used as the VOL for deployment and provided as an external connection destination of the E-VOL 520 of another storage node 100.

As a result, even in the information processing system that is provided across sites such as in the hybrid cloud environment, the scale-out process can be instantly executed in the cloud site.

### Third Embodiment

In the second embodiment, in the hybrid cloud environment, after fully copying the data of the VOL 500 from the on-premises site 20, the scale-out process may be performed in the cloud site as the scale-out process described in the first embodiment. The scale-out process can be instantly executed on the VOL 500b in the storage node 100a in the cloud site 30, but the data copy processing time of the VOL 500a from the on-premises site 20 to the cloud site 30 is required.

In a third embodiment, the scale-out process can be executed using the external connection and the snapshot across sites without fully copying the data of the VOL 500 from the on-premises site 20 to the cloud site 30.

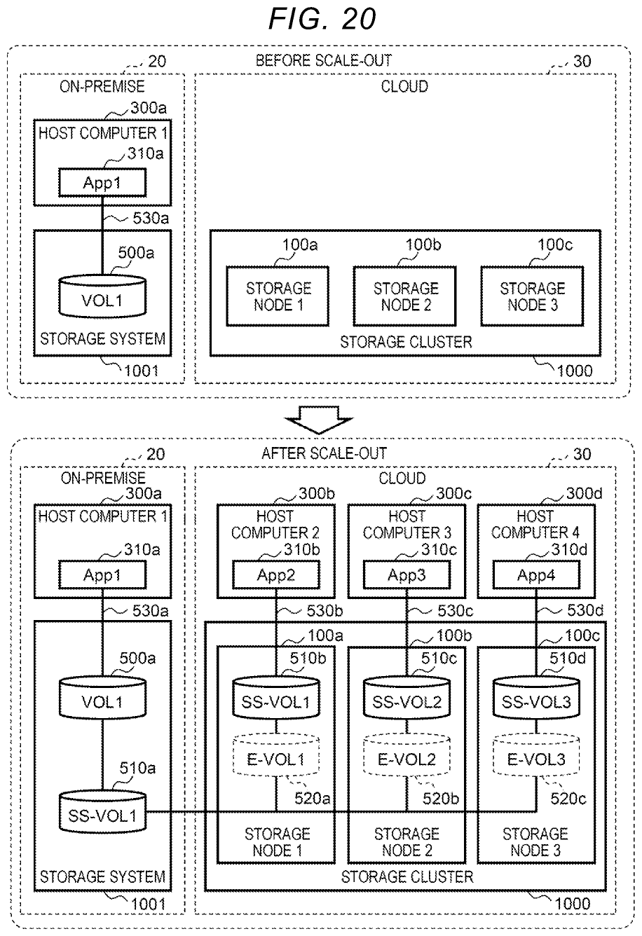

FIG. 20 is a diagram illustrating the summary of a scale-out process of the information processing system according to the third embodiment.

A configuration before the scale-out is the same as that of the second embodiment, and thus the description thereof will be omitted.

After the scale-out, the E-VOL 520a that is externally connected to the SS-VOL 510a based on a scale-out target VOL 500a of the storage system 1001 in the on-premises site 20 is allocated in the storage node 100a. The E-VOL 520a is deployed as the scale-out target VOL by the scale-out process in each of the storage nodes and is finally provided to the host computers as the SS-VOL 510b, the SS-VOL 510c, and an SS-VOL 510d. As the scale-out process, the scale-out process described in the first embodiment may be executed by using the E-VOL 520a as the scale-out target VOL. Note that the SS-VOL 510 based on the E-VOL 520a is not provided as the VOL for deployment, and the E-VOL 520a as the VOL for deployment is provided as an external connection destination of the E-VOL 520 of another storage node 100.

When a read/write request for the E-VOL 520a is received, a data block of the read/write destination is transmitted from the SS-VOL 510a of the storage system 1001. When a write request for the E-VOL 520a is received, a data block of the write destination is transmitted to the SS-VOL 510a of the storage system 1001. To reduce the communication processing time during the data write operation and to deploy the data to the other nodes without including updated data from the host computer 310b when providing the VOL for deployment in the storage cluster 1000, the SS-VOL 510b based on the E-VOL 520a is generated and provided to the host computer 300b. The data block transmitted from the SS-VOL 510a of the storage system 1001 in response to the read/write request is cached to the memory 120 of the storage node 100a. As a result, the data transmission time from the SS-VOL 510a of the storage system 1001 in response to the read/write request for the same data block can be reduced.

When a read/write request for the E-VOL 520b and an E-VOL 520c is received, a data block of the read/write destination is transmitted from the E-VOL 520a. By generating the SS-VOL 510c and the SS-VOL 510d for the E-VOL 520b and the E-VOL 520c, respectively, updated data can be stored in each of the storage nodes 100 without being reflected on the E-VOL 520a.

As a result, even in the information processing system provided across sites such as the hybrid cloud environment, the scale-out process can be instantly executed in the cloud site without waiting for the data copy time from the on-premises site. The E-VOL 520a functions as a cache of the E-VOL 520b and the E-VOL 520c for the SS-VOL 510a, and when the data block of the read/write destination of the E-VOL 520b and the E-VOL 520c is cached to the E-VOL 520a, the transmission of the data block from the SS-VOL 510a of the storage system 1001 is unnecessary, the data block transmission time from the storage system 1001 to the storage cluster 1000 can be reduced, and a decrease in the I/O processing performance for the SS-VOL 510c and the SS-VOL 510d based on the E-VOL 520b and the E-VOL 520c can be prevented. The data transmission from the on-premises site 20 to the cloud site 30 is communication across sites, and the communication time is long. Therefore, the above-described reduction in communication is effective.

In the second and third embodiments, the environment across the on-premises site and the cloud site has been described. The sites are not limited to the on-premises site and the cloud site, and an embodiment that is provided across different sites may be adopted as a high-level concept.

As described above, the information processing system according to the disclosure includes: a secondary use source system (the storage node 100a or the storage system 1001) that includes a target volume as a target for secondary use; and one or a plurality of secondary use destination nodes (the storage nodes 100) that are used for secondary use of the target volume, in which any one of the secondary use source system or the secondary use destination node includes a first replicated volume (the snapshot volume 510a or the volume 500b) that is replicated from the target volume, a node that is the secondary use destination node and does not include the first replicated volume includes an external connection volume (the external connection volume 520) that is externally connected to the first replicated volume and a second replicated volume (the snapshot volume 510) that is a snapshot of the external connection volume, and a data writing operation for the secondary use is reflected on the second replicated volume.

Therefore, the secondary use can start without fully copying the target volume to each of the secondary use destination nodes, and thus the convenience is improved. The amount of data transmitted via a network can be reduced. Therefore, a network load and the power consumption thereof can be reduced.

In one configuration example, the secondary use source system includes a snapshot volume of the target volume as the first replicated volume.

The secondary use source system includes a first secondary use destination node and a second secondary use destination node as the secondary use destination nodes, the first secondary use destination node includes an external connection volume that is externally connected to the first replicated volume, and the second secondary use destination node includes an external connection volume that is externally connected to the external connection volume of the first secondary use destination node.

In such configuration, the secondary use destination node accesses a secondary use source snapshot volume to read and write data when needed. Therefore, the secondary use can instantly start without fully copying the target volume.

In one configuration example, the secondary use source system includes a first secondary use destination node and a second secondary use destination node as the secondary use destination nodes, the first secondary use destination node includes the first replicated volume that is fully copied from the target volume and a second replicated volume that is a snapshot of the first replicated volume, and the second secondary use destination node includes an external connection volume that is externally connected to the first replicated volume and a second replicated volume that is a snapshot of the external connection volume.

In such configuration, when data that is fully copied from the target volume is generated once in one of the secondary use destination nodes, the data can be secondarily used in a plurality of secondary use destination nodes. Therefore, even when the communication speed between the secondary use source and the secondary use destination is slow and the amount of read data is large, the performance in the secondary use can be ensured.

The secondary use source system and the secondary use destination node may be allocated in the same site. The secondary use source system and the secondary use destination node may be allocated in different sites. A plurality of secondary use destination nodes may be allocated across a plurality of sites, and a network distance between the plurality of sites where the secondary use destination nodes are allocated may be less than a network distance between the secondary use source system and the secondary use destination nodes. Here, the network distance may refer to any one of the length of a physical network wiring, the communication speed of the network, or the performance of the network. The secondary use source system may be allocated in an on-premises environment, and the secondary use destination nodes may be allocated in a cloud environment.

For example, the system according to the disclosure preferentially generates the second replicated volume in a secondary use destination node having a low load among the plurality of secondary use destination nodes.

A secondary use destination node as a generation destination of the second replicated volume can also be determined depending on performances and/or uses of the plurality of secondary use destination nodes.

In the system according to the disclosure, a management device for managing the entire information processing system executes a process related to generation of the second replicated volume in response to an instruction from a management client that is operated by a manager.

Alternatively, a configuration can also be adopted in which a management device for managing the entire information processing system regularly monitors operating information of the secondary use destination node, determines whether generation of the second replicated volume is necessary based on the operating information of the secondary use destination node and a preset required performance, and generates the second replicated volume.

As such, the system according to the disclosure can be applied to various environments and can be flexibly operated depending on environments.

The present invention is not limited to the embodiment and includes various modification examples. For example, the embodiments have been described in detail to easily describe the present invention, and the present invention does not necessarily include all the configurations described above. Not only deletion of the configurations but also replacement or addition of the configurations can also be made.

For example, in the above-described embodiments, a configuration where a device that detects abnormality from data and a device that updates a model are integrated has been described. However, a configuration where the abnormality detection and the model update are executed by separate devices may also be adopted.

What is claimed is:

1. A storage system comprising a plurality of nodes each of which includes a processor, wherein
when a replication source volume in a replication source storage system connected to the storage system is replicated to a plurality of nodes of the storage system,
any one of the processors
generates a first replicated volume by replicating the replication source volume of the replication source storage system in a first node among the plurality of nodes, and
generates a second replicated volume mapped to the first replicated volume in a second node among the plurality of nodes.

2. The storage system according to claim 1, wherein
the second node generates a snapshot of the second replicated volume and provides the generated snapshot to a host,
when a read request from the host for the snapshot of the second replicated volume is received, the processor of the second node accesses the first replicated volume of the first node as a mapping destination via the second replicated volume to read data, and
when a write request from the host for the snapshot of the second replicated volume is received, data is stored in the second node without accessing the first replicated volume.

3. The storage system according to claim 2, further comprising a third node belonging to a plurality of nodes, wherein
when a replication source volume in the replication source storage system is replicated to the third node,
a third replicated volume mapped to the first replicated volume is generated in the third node among the plurality of nodes.

4. The storage system according to claim 1, wherein
when the first replicated volume is generated,
the replication source storage system generates a snapshot of the replication source volume, and
the first node generates the first replicated volume mapped to the snapshot of the replication source volume.

5. The storage system according to claim 4, wherein
the first node generates a snapshot of the second replicated volume and provides the generated snapshot to a host,
when a read request from the host for the snapshot of the first replicated volume is received and when a read request for the snapshot of the second replicated volume is transmitted from the second node, the processor of the first node accesses the snapshot of the replication source volume as the mapping destination via the first replicated volume to read data, and
when a write request from the host for the snapshot of the first replicated volume is received, data is stored in the first node without accessing the replication source storage system.

6. The storage system according to claim 1, wherein
data is input to and output from the replication source volume as a business,
data is input to and output from the first node and the second node as a secondary use of data of the replication source volume, and
after being generated, the first and second replicated volumes are not affected by the input and output of data to and from the replication source volume due to the snapshot of the replication source volume.

7. The storage system according to claim 1, wherein
the first and second nodes are cloud storages.

8. The storage system according to claim 7, wherein
the first node and the second node are allocated in the same site, and
the replication source storage system is an on-premises or cloud storage and is allocated in a site different from that of the first node and the second node.

9. The storage system according to claim 7, wherein
a network distance between the first node and the second node is less than a network distance between the replication source storage system and the second node.

10. A management method of a storage system including a plurality of nodes each of which includes a processor,
the management method comprising:
when a replication source volume in a replication source storage system connected to the storage system is replicated to a plurality of nodes of the storage system,
allowing any one of the processors to
generate a first replicated volume by replicating the replication source volume of the replication source storage system in a first node among the plurality of nodes; and
generate a second replicated volume mapped to the first replicated volume in a second node among the plurality of nodes.
